(19) United States
(12) Patent Application Publication
(10) Pub. No.: US 2021/0064862 A1
(43) Pub. Date: Mar. 4, 2021

(54) SYSTEM AND A METHOD FOR DEVELOPING A TOOL FOR AUTOMATED DATA CAPTURE

(71) Applicant: Cognizant Technology Solutions India Pvt. Ltd., Chennai (IN)

(72) Inventors: Peeta Basa Pati, Bangalore (IN); Biju Sukumaran, Bangalore (IN); Vamshi Pendli, Khammam (IN); Dularish Kuttuwa Ayankaran, Chennai (IN)

(21) Appl. No.: 16/655,426

(22) Filed: Oct. 17, 2019

(30) Foreign Application Priority Data
Aug. 28, 2019 (IN) 201941034653

(51) Int. Cl. G06K 9/00; G06F 17/24; G06F 16/901

(52) U.S. Cl. CPC G06K 9/00456; G06K 9/00463; G06F 16/901; G06F 17/248; G06F 17/241

(57) ABSTRACT

The present invention discloses a system and a method for developing a tool for automated data capture. In particular the present invention provides for extracting document records associated with each historical enterprise-document based on a classification of historical enterprise-documents. Further, a meta-data for each historical enterprise-document and corresponding document records is generated. A plurality of data point representation lists are generated based on each document record. A representation template for each historical enterprise-document is generated based on the corresponding meta-data and data representation list. Further, data point identification models are generated for each category of historical documents using plurality of historical enterprise documents of respective category and the corresponding representation templates. Finally, data capture rules for capturing data value associated with data points in each incoming enterprise-document are generated within data point identification model. The generated models are implemented by the tool of the present invention for automated data capture.

### FIELD OF THE INVENTION

The present invention relates generally to the field of data processing and analytics. More particularly, the present invention relates to a system and a method for developing a tool for automated data capture.

### BACKGROUND OF THE INVENTION

Many of the existing data capture tools use one or more data capture models. The one or more data capture models define a mechanism to identify, extract and modify business relevant data from incoming documents for downstream processing and storage in a database. Each of the one or more data capture models are customized based on the incoming documents and data needs of respective enterprises. The one or more data capture models may be defined manually if rule based or may be defined based on a data-training process using statistical machine learning techniques.

The data-training process includes developing training data by manually annotating template documents and training the data capture model to extract data from incoming documents based on the training data. The template documents are representative of sample incoming documents selected for generating training data. However, the process of developing training data manually lacks precision due to human errors. Further, the process of developing the training data is time consuming and delays the process of model generation. Yet further, the process of developing the training data is costly.

In light of the above drawbacks, there is a need for a system and a method for developing a tool for automated data capture. There is a need for a system and a method that provides automated generation of training data. Further, there is a need for a system and method which significantly reduces the time for generating training data. Furthermore, there is a need for a system and a method which substantially reduces manual efforts and enhances data capture accuracy by generating data capture tools based on the automatically generated training data. Yet further, there is a need for a system and a method which is economical, and can be easily deployed and maintained.

### SUMMARY OF THE INVENTION

In various embodiments of the present invention, a method for developing a tool for automated data capture from incoming enterprise documents is provided. The method is implemented by at least one processor executing program instructions stored in a memory. The method comprises generating a metadata for each of the plurality of historical enterprise-documents based on corresponding data point representation list. The data point representation list includes multiple representations of data values associated with data points in the document records corresponding to historical enterprise documents. The method further comprises generating a representation template for each of the respective historical enterprise document based on the corresponding metadata. Further, the method comprises generating, one or more data point identification models for each category of historical documents using the plurality of historical enterprise documents of respective category and the corresponding representation templates. Furthermore, the method comprises generating one or more data capture rules within each of the data point identification models, wherein the one or more data capture rules cause the corresponding data point identification model to capture a data value associated with data points in each incoming enterprise-document and transform the data values for storage into another database. Finally, the method comprises developing the tool for automated data capture from the generated one or more data point identification models and the generated one or more rules.

In an embodiment of the present invention, a method for generating training data for developing a tool for automated data capture from incoming enterprise documents is provided. The method is implemented by at least one processor executing program instructions stored in a memory. The method comprises extracting one or more document records corresponding to respective plurality of historical enterprise-documents using an index matching technique. Further, the method comprises generating a metadata for each of the plurality of historical enterprise-documents based on data point representation list associated with corresponding one or more document records. The data point representation list includes multiple representations of data values associated with respective data points in the document records corresponding to historical enterprise documents. Furthermore, the method comprises generating a representation template for respective historical enterprise documents based on the corresponding metadata.

In various embodiments of the present invention, a system for developing a tool for automated data capture from incoming enterprise documents is provided. The system comprises a memory storing program instructions, a processor configured to execute program instructions stored in the memory, and a tool development engine in communication with the processor. The system is configured to generate a metadata for each of the plurality of historical enterprise-documents based on corresponding data point representation lists. The data point representation list includes multiple representations of data values associated with data points in the document records corresponding to historical enterprise documents. Further, the system is configured to generate a representation template for each of the respective historical enterprise document based on the corresponding metadata. Furthermore, the system is configured to generate one or more data point identification models for each category of historical documents using the plurality of historical enterprise documents of respective category and the corresponding representation templates, where the data point identification models are implementable by the tool for automated data capture. Yet further, the system is configured to generate one or more data capture rules within each of the data point identification models. The one or more data capture rules cause the corresponding data point identification model to capture a data value associated with data points in each incoming enterprise-document and transform the data values for storage into another database. Finally, the system is configured to develop the tool for automated data capture from the generated one or more data point identification models and the generated one or more rules.

In an embodiment of the present invention, a system for generating training data for developing a tool for automated data capture from incoming enterprise documents is provided. The system comprises a memory storing program instructions, a processor configured to execute program instructions stored in the memory, and a tool development engine in communication with the processor. The system is configured to extract one or more document records corresponding to respective plurality of historical enterprise-documents using an index matching technique. Further, the system is configured to generate a metadata for each of the plurality of historical enterprise-documents based on data point representation list associated with corresponding one or more document records. The data point representation list includes multiple representations of data values associated with respective data points in the document records corresponding to historical enterprise documents. Furthermore, the system is configured to generate a representation template for respective historical enterprise-documents based on the corresponding metadata, where the one or more data point identification models are generated using the plurality of historical enterprise documents of a category and the corresponding representation templates. The data point identification models are implementable by the tool for automated data capture.

### BRIEF DESCRIPTION OF THE ACCOMPANYING DRAWINGS

The present invention is described by way of embodiments illustrated in the accompanying drawings wherein:

FIG. 1 illustrates a block diagram of a system for developing a tool for automated data capture from incoming relevant documents, in accordance with an embodiment of the present invention;

FIG. 1A is an exemplary enterprise document of cheque category representing document records and associated data points, in accordance with various embodiments of the present invention;

FIG. 1B is another exemplary enterprise document of invoice category representing document records and associated data points, in accordance with various embodiments of the present invention;

FIG. 2 is a flowchart illustrating a method for developing a tool for automated data capture from incoming relevant documents, in accordance with an embodiment of the present invention; and

FIG. 3 illustrates an exemplary computer system in which various embodiments of the present invention may be implemented.

### DETAILED DESCRIPTION OF THE INVENTION

The present invention discloses a system and a method for developing a tool for automated data capture. In particular, the present invention provides for automated generation of training data using a plurality of historical enterprise-documents and one or more document records associated with respective enterprise-documents. Each document record is representative of electronic data associated with one or more data points and data values associated with respective data points in a coherent region of corresponding enterprise document. The system and method of the present invention, classifies the historical enterprise-documents into one or more categories based on a document type and extracts document records associated with each historical enterprise-document. Further, a meta-data for each historical enterprise-document and corresponding document records is generated. A plurality of data point representation lists are generated based on each document record. Each data point representation list includes multiple representations of data values associated with respective data points of respective document record. A representation template for each of the historical enterprise-documents is generated based on the corresponding meta-data and the data representation list. Further, one or more data point identification model are generated for each category of historical documents using the plurality of historical enterprise documents of respective category and the corresponding representation templates. Finally, one or more data capture rules for capturing data value associated with data points in each incoming enterprise-document are generated within corresponding data point identification model. The present invention facilitates the use of existing document records (historical data) and historical enterprise-documents to initiate a machine learning mechanism resulting in creation of models. The generated models are implemented by the tool of the present invention for automated data capture.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

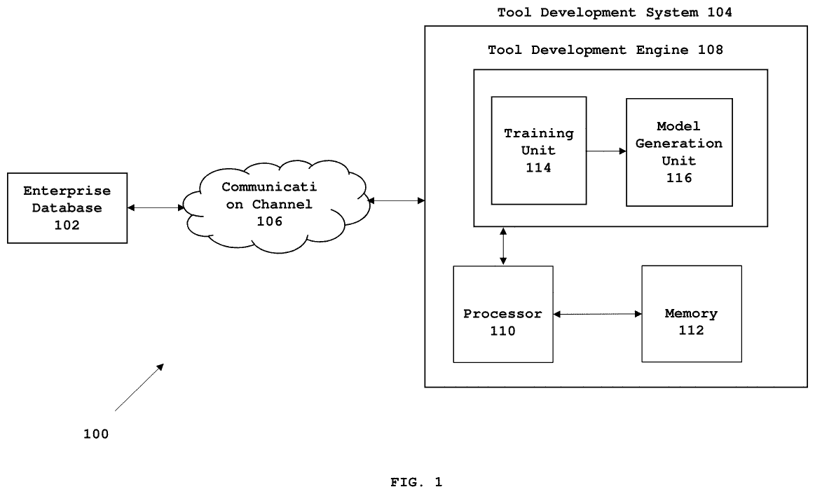

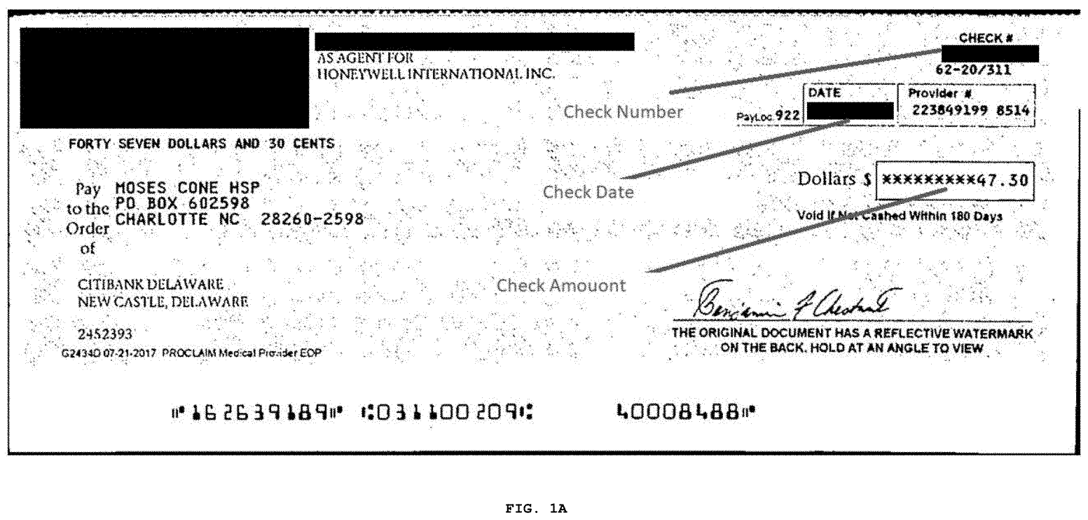

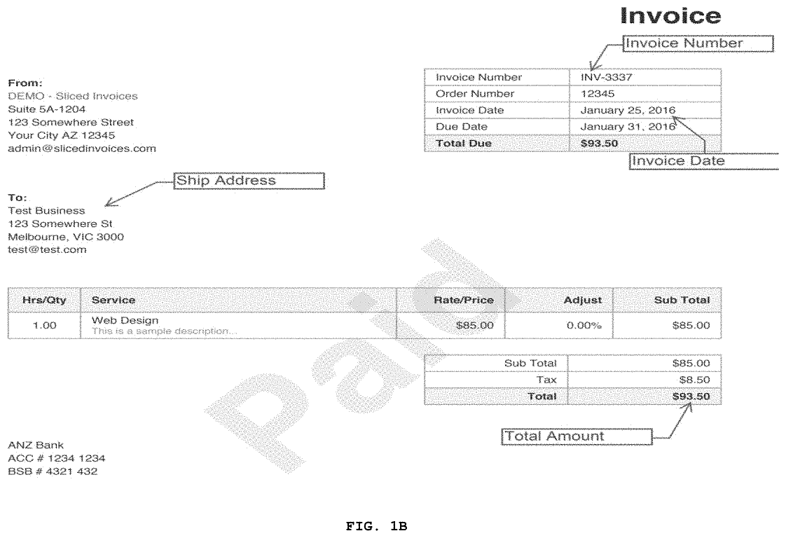

FIG. 1 illustrates a block diagram of a system for developing a tool for automated data capture from incoming relevant documents, in accordance with an embodiment of the present invention;

Referring to FIG. 1, in an embodiment of the present invention, illustrated is a development environment 100 for a tool for automated data capture. The development environment 100 comprises an enterprise database 102, and a system for developing a tool for automated data capture hereinafter referred to as a tool development system 104.

In various embodiments of the present invention, the enterprise database 102 is a database which may be maintained in one or more storage devices. In an embodiment of the present invention, the storage devices may be at separate locations. The enterprise database 102 comprises one or more categories of a plurality of historical enterprise-documents and one or more document records associated with each enterprise-document. In an embodiment of the present invention, each historical enterprise-document is converted into an electronic document prior to storage in the enterprise database 102 using techniques such as optical character recognition [OCR]. In an embodiment of the present invention, the enterprise database 102 is further configured to store incoming enterprise-documents. In an exemplary embodiment of the present invention, the plurality of historical enterprise-documents are representative of all the previously received relevant documents. In an embodiment of the present invention, the plurality of incoming enterprise-documents are representative of new relevant documents. The examples of relevant documents may include, but are not limited to invoices, cheque, contract document, patent document, forms or any other document having some predefined structure, shape or attributes. In an exemplary embodiment of the present invention, the one or more categories of historical enterprise-documents may include, but are not limited to, cheques as shown in FIG. 1A, invoices as shown in FIG. 1B, patent documents (not shown), and any other structured or non-structured document. The categories of incoming enterprise-documents are implied from the categories of historical enterprise-documents. Each document record is representative of electronic data associated with one or more data points and data values associated with respective data points in a coherent region of corresponding enterprise document. In an embodiment of the present invention, the coherent region may include, but is not limited to, the entire enterprise document, region of enterprise document encompassing one of the categories of the enterprise document and region of enterprise document comprising related data points. In an exemplary embodiment of the present invention, the electronic data of document records is the data capable of being exchanged and transmitted between machines. The data records are generated by manually inputting data from each enterprise-document in the enterprise database 102. In another embodiment of the present invention, the document records may be generated by using one or more data transformation technique. Referring to FIG. 1A, check number, check date and check amount are examples of data points associated with the cheque document. The data record associated with the cheque document is representative of electronic data associated with check number, check date and check amount. Similarly, as illustrated in FIG. 1B, invoice number, invoice date, ship address and total amount are examples of data points associated with the invoice document. The data record associated with the invoice document is representative of electronic data associated with invoice number, invoice date, ship address and total amount.

In an embodiment of the present invention, as shown in FIG. 1, the tool development system 104 interfaces with the enterprise database 102 over a communication channel 106 to retrieve the plurality of historical enterprise-documents and document records associated with each historical enterprise-document. In an embodiment of the present invention, examples of the communication channel may include a physical transmission medium, such as, a wire, or a logical connection over a multiplexed medium, such as, a radio channel in telecommunications and computer networking. The examples of radio channel in telecommunications and computer networking may include a Local Area Network (LAN), a Metropolitan Area Network (MAN), and a Wide Area Network (WAN).

The tool development system 104 comprises a tool development engine 108, a processor 110 and a memory 112. The tool development engine 108 is operated via the processor 110 specifically programmed to execute instructions stored in the memory 112 for executing functionalities of the system 104 in accordance with various embodiments of the present invention. In various embodiments of the present invention, the tool development engine 108 is configured to analyze and categories documents, generate document representation template, formulate rules and generate data capture models.

In various embodiments of the present invention, tool development engine 108 has multiple units which work in conjunction with each other for developing a tool for automated data capture. The various units of the tool development engine 108 are operated via the processor 110 specifically programmed to execute instructions stored in the memory 112 for executing respective functionalities of the units of the system 104 in accordance with various embodiments of the present invention.

In an embodiment of the present invention, the tool development engine 108 comprises a training unit 114 and a model generation unit 116. In operation, the training unit 114 is configured to retrieve a plurality of historical enterprise-documents from the enterprise database 102. The training unit 114 classifies the plurality of historical enterprise-documents into one or more categories based on a document type. In an embodiment of the present invention, the training unit 114 uses one or more classification techniques to categorize historical enterprise-documents. In an exemplary embodiment of the present invention, the classification technique includes categorizing the historical enterprise-documents based on appearance of one or more text strings or phrases. In another exemplary embodiment of the present invention, the classification technique includes categorizing the historical enterprise-documents based on frequency of occurrence of one or more terms in the document. In another exemplary embodiment of the present invention, the classification technique includes categorizing the historical enterprise-documents based on text layout and size of the document. In yet another exemplary embodiment of the present invention, the training unit 114 may use metadata associated with channel of reception of historical enterprise-documents, storage information and nomenclature associated with the historical enterprise-documents along with one or more classification techniques as described above for categorizing the historical enterprise-documents. In an exemplary embodiment of the present invention, the historical enterprise-documents are invoices, cheques and patent documents. The training unit 114 classifies the plurality of historical enterprise-documents into three categories invoices, cheques and patent documents in accordance with the exemplary embodiment of the present invention. Each category of historical enterprise-documents may have respective structure and attributes, where the attributes are representative of data points and associated location. Further, the historical enterprise-documents associated with a single category may include varying structure and attributes, for e.g.: an invoice from first entity may vary from an invoice from second entity. In various embodiments of the present invention, the training unit 114, extracts document records associated with each enterprise-document for one or more categories. In an embodiment of the present invention, the one or more categories may be pre-selected. In an embodiment of the present invention, the training unit 114 uses an index matching technique to identify one or more document records associated with respective enterprise-document.

The training unit 114 is further configured to generate metadata for each of the historical enterprise-documents based on the corresponding one or more document records. In particular, the training unit 114 is configured to generate a data point representation list corresponding to data values associated with respective plurality of data points in respective document records using a reverse transformation technique using a reverse transformation technique. Each data point representation list includes multiple representations of data values associated with data points in respective document records associated with corresponding historical enterprise documents. In an exemplary embodiment of the present invention as shown in FIG. 1B, where the historical enterprise-document is an invoice, the invoice date is a data point and the value Jan. 25, 2016 is the data value. The invoice date in the enterprise document may be in a format such as month dd, yyyy and the date in the document record may be in MMDDYYYY format. The training unit 114 is configured to generate a data point representation list for each format of date.

In various embodiments of the present invention, the training unit 114 is configured to identify each data point associated with each document record in the corresponding historical enterprise-document based on the corresponding data point representation list. The training unit 114 marks the position of each identified data point with a special annotation on the corresponding enterprise-documents. The training unit 114 repeats the step of marking for respective historical enterprise documents. The training unit 114 uses the special annotation and the data point representation list associated with corresponding historical enterprise-documents to generate corresponding meta-data for respective enterprise-documents. In an embodiment of the present invention, the metadata may include, but is not limited to, information associated with plurality of data points of an enterprise-document, position of data points in the enterprise-document such as, but not limited to coordinate data, context data, document type and document structure. The training unit 114 generates a representation template for each of the plurality of historical enterprise-documents associated with respective category based on corresponding meta-data. Each representation template represents multiple data points and meta-data associated with the corresponding historical enterprise documents.

The model generation unit 116, receives the generated representation templates for each of the plurality of enterprise-documents. The model generation unit 116 generates one or more data point identification models for each category of enterprise-document by training the model with the plurality of historical enterprise-documents associated with the respective category and the corresponding representation templates.

In an embodiment of the present invention, the model generation unit 116 is configured to generate data capture rules within each of generated data point identification models associated with a category of historical enterprise-documents. The data capture rules cause the corresponding data point identification model to capture a data value associated with data points in each incoming enterprise-document and transform the data values for storage into another database (not shown). In particular, the model generation unit 116 receives the plurality of historical enterprise-documents and corresponding document records as extracted by the training unit 114. The model generation unit 116 searches for each data point associated with respective document records in the corresponding historical enterprise-documents using the corresponding data point representation list. Further, the model generation unit 116 analyses a pattern of appearance of data value associated with each data point in the respective categories of historical enterprise-documents based on the corresponding data point representation list. The model generation unit 116 determines a relationship between the data value associated with each data point in the respective categories of enterprise documents and data value in the corresponding historical enterprise-documents. Further, the model generation unit 116, identifies a data transformation mechanism for the data value of each data point associated with respective historical enterprise-documents using the determined relationship. The data transformation mechanism is representative of the mechanism to transform the data as it appears in a document into a format or type it should be represented in the enterprise database 102.

The model generation unit 116 performs a check to determine the availability of one or more keywords before and/or after the data value associated with each identified data point in respective historical enterprise-documents of a particular category. Further, the model generation unit 116 performs a check to determine the availability of one or more static texts in respective historical enterprise-documents, if no keywords exists before or after the data value corresponding identified data points. In an embodiment of the present invention, each static text is representative of the text that is static in relation to any other text in the documents and appears in multiple historical enterprise-documents of a category. The model generation unit 116, further builds a relationship between the static text and the data values associated with respective data points by using one or more techniques including, but not limited to, coordinate geometry and/or pattern matching technique.

The identified keywords and the static text associated with corresponding historical enterprise-documents may be used for capturing the data value of each data points associated with respective enterprise-documents. The model generation unit 116, generates one or more data capture rules for each of the categories of the historical enterprise document using the identified data transformation mechanism, and at least one of the identified keywords and the static text associated with corresponding historical enterprise-documents. The one or more data capture rules cause the corresponding data point identification model to capture a data value associated with data points in each incoming enterprise-document and transform the data values for storage into another database. Finally, the model generation unit 116 develops a tool for automated data capture from the generated data point identification model and the generated one or more rules.

In another embodiment of the present invention, the tool development system 104 may be implemented in a cloud computing architecture in which data, applications, services, and other resources are stored and delivered through shared data-centers. In an exemplary embodiment of the present invention, the functionalities of the tool development system 104 are delivered as software as a service (SAAS).

In another embodiment of the present invention, the tool development system 104 may be implemented as a client-server architecture, wherein a client terminal device (not-shown) accesses a server hosting the system 104 over a communication network (not shown).

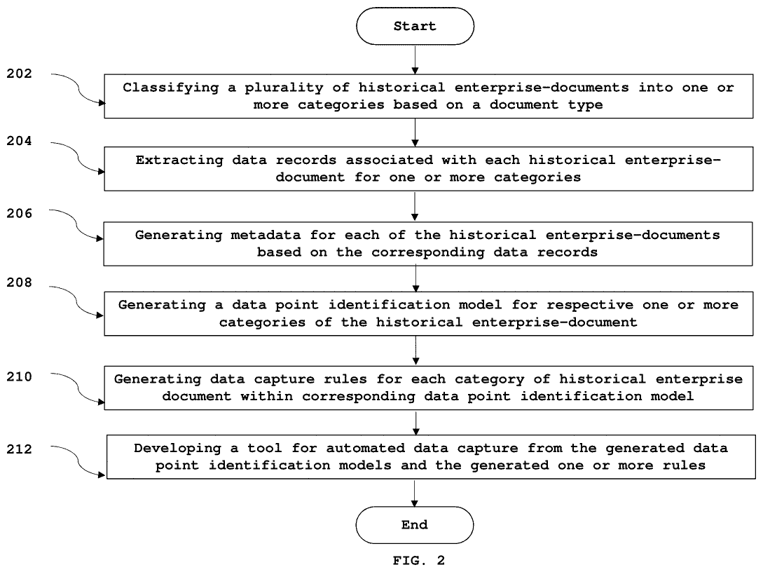

FIG. 2 is a flowchart illustrating a method for developing a tool for automated data capture from incoming relevant documents, in accordance with an embodiment of the present invention.

At step 202, a plurality of historical enterprise-documents are classified into one or more categories based on a document type. In an embodiment of the present invention, a plurality of historical enterprise-documents are retrieved from an enterprise database 102 of FIG. 1. Each enterprise document is representative of a previously received relevant document. The plurality of historical enterprise-documents are classified into one or more categories based on a document type using one or more classification techniques. In an exemplary embodiment of the present invention, the classification technique includes categorizing the historical enterprise-documents based on appearance of one or more text strings or phrases. In another exemplary embodiment of the present invention, the classification technique includes categorizing the historical enterprise-documents based on frequency of occurrence of one or more terms in the document. In another exemplary embodiment of the present invention, the classification technique includes categorizing the historical enterprise-documents based on text layout and size of the document. In an exemplary embodiment of the present invention, the historical enterprise-documents are invoices, cheques and patent documents. The plurality of historical enterprise-documents are classified into three categories invoices, cheques and patent documents in accordance with the exemplary embodiment of the present invention. Each category of historical enterprise-documents may have respective structure and attributes, where the attributes are representative of data points and associated location. Further, the historical enterprise-documents associated with a single category may include varying structure and attributes, for e.g.: an invoice from first entity may vary from an invoice from second entity.

At step 204, document records associated with each historical enterprise-document for one or more categories are extracted. In an embodiment of the present invention, an index matching technique is used to identify one or more document records associated with respective enterprise-document from the enterprise database. Each document record is representative of electronic data associated with one or more data points and data values associated with respective data points in a coherent region of corresponding enterprise document. In an embodiment of the present invention, the coherent region may include, but is not limited to, the entire enterprise document, region of enterprise document encompassing one of the categories of the enterprise document and region of enterprise document comprising related data points. In an exemplary embodiment of the present invention, the electronic data of document records is the data capable of being exchanged and transmitted between machines.

At step 206, metadata is generated for each of the historical enterprise-documents based on the corresponding one or more document records. In particular, the training unit 114 is configured to generate a data point representation list corresponding to data values associated with respective plurality of data points in respective document records using a reverse transformation technique. Each data point representation list includes multiple representations of data values associated with data points in respective document records associated with corresponding historical enterprise documents. In an exemplary embodiment of the present invention as shown in FIG. 1B, where the historical enterprise-document is an invoice, the invoice date is a data point and the value Jan. 25, 2016 is the data value. The invoice date in the enterprise document may be in a format such as month dd, yyyy and the date in the document record may be in MMDDYYYY format. A data point representation list including all formats of date is generated.

In an embodiment of the present invention, a search is performed to identify each data point associated with each document record in the corresponding historical enterprise-document based on the corresponding data point representation list. The position of each identified data point is marked with a special annotation on the corresponding enterprise-documents. The step of marking is repeated for respective historical enterprise documents. Each special annotation and the data point representation list associated with corresponding historical enterprise-documents is used to generate corresponding meta-data for respective enterprise-documents. In an embodiment of the present invention, the metadata may include, but is not limited to, information associated with each of the one or more data points of an enterprise-document, position of data points in the enterprise-document such as, but not limited to coordinate data, context data, information associated with document type and document structure.

At step 208, a data point identification model for respective one or more categories of enterprise-document is generated. In particular, a representation template is generated for each of the plurality of historical enterprise-documents associated with respective category based on corresponding meta-data. Each representation template represents multiple data points and meta-data associated with the corresponding historical enterprise documents. Further, a data point identification model is generated for each category of enterprise-document by training the model with the historical enterprise-documents and the corresponding representation templates associated with the respective category.

At step 210, data capture rules for each category of historical enterprise-documents are generated within the corresponding data point identification model. The data capture rules cause the corresponding data point identification model to capture a data value associated with data points in each incoming enterprise-document and transform the data values for storage into another database (not shown).

In particular, a search is performed for each data point associated with respective document records in the corresponding historical enterprise-documents using the corresponding data point representation list. Further, a pattern of appearance of the data value associated with each data point in the respective categories of enterprise documents is analyzed based on the corresponding data point representation list. A relationship between the data value associated with each data point in the respective categories of enterprise documents and data value in the corresponding historical enterprise-documents is determined. A data transformation mechanism for the data value of each data point associated with respective historical enterprise-documents is identified using the determined relationship. The data transformation mechanism is representative of the mechanism to transform the data as it appears in a document into a format or type it should be represented in the enterprise database 102. Further, a check is performed to determine availability of one or more keywords at least before or after the data value associated with corresponding identified data points in respective historical enterprise-documents for each category. Furthermore, a check is performed to determine the availability of one or more static texts in respective historical enterprise-documents, if no keywords exists before or after the data value corresponding to the identified data points. In an embodiment of the present invention, each static text is representative of the text that is static in relation to any other text in the documents and appears in multiple historical enterprise-documents of a category. A relationship is buildup between the static text and the data values associated with respective data points using one or more techniques including, but not limited to, coordinate geometry and/or pattern matching technique. Finally, one or more data capture rules are generated for each of the categories of the historical enterprise document using the identified data transformation mechanism, and at least one of the identified keywords and the static text associated with corresponding historical enterprise-documents.

At step 212 a tool for automated data capture is developed from the generated data point identification models and the generated one or more rules.

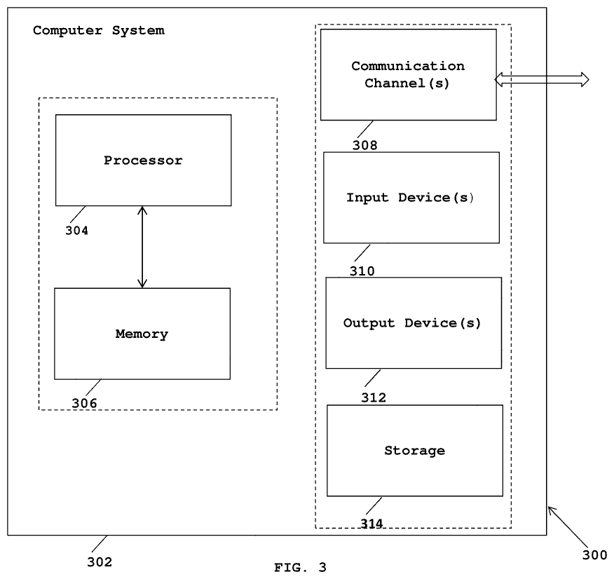

FIG. 3 illustrates an exemplary computer system in which various embodiments of the present invention may be implemented. The computer system 302 comprises a processor 304 and a memory 306. The processor 304 executes program instructions and is a real processor. The computer system 302 is not intended to suggest any limitation as to scope of use or functionality of described embodiments. For example, the computer system 302 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 306 may store software for implementing various embodiments of the present invention. The computer system 302 may have additional components. For example, the computer system 302 includes one or more communication channels 308, one or more input devices 310, one or more output devices 312, and storage 314. An interconnection mechanism (not shown) such as a bus, controller, or network, interconnects the components of the computer system 302. In various embodiments of the present invention, operating system software (not shown) provides an operating environment for various softwares executing in the computer system 302, and manages different functionalities of the components of the computer system 302.

The communication channel(s) 308 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 310 may include, but not limited to, a keyboard, mouse, pen, joystick, trackball, a voice device, a scanning device, touch screen or any another device that is capable of providing input to the computer system 302. In an embodiment of the present invention, the input device(s) 310 may be a sound card or similar device that accepts audio input in analog or digital form. The output device(s) 312 may include, but not limited to, a user interface on CRT or LCD, printer, speaker, CD/DVD writer, or any other device that provides output from the computer system 302.

The storage 314 may include, but not limited to, magnetic disks, magnetic tapes, CD-ROMs, CD-RWs, DVDs, flash drives or any other medium which can be used to store information and can be accessed by the computer system 302. In various embodiments of the present invention, the storage 314 contains program instructions for implementing the described embodiments.

The present invention may suitably be embodied as a computer program product for use with the computer system 302. The method described herein is typically implemented as a computer program product, comprising a set of program instructions which is executed by the computer system 302 or any other similar device. The set of program instructions may be a series of computer readable codes stored on a tangible medium, such as a computer readable storage medium (storage 314), for example, diskette, CD-ROM, ROM, flash drives or hard disk, or transmittable to the computer system 302, via a modem or other interface device, over either a tangible medium, including but not limited to optical or analogue communications channel(s) 308. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention.

We claim:

1. A method for developing a tool for automated data capture from incoming enterprise documents, wherein the method is implemented by at least one processor executing program instructions stored in a memory, the method comprising:
generating, by the processor, a metadata for each of the plurality of historical enterprise-documents based on corresponding data point representation list, wherein the data point representation list includes multiple representations of data values associated with data points in the document records corresponding to historical enterprise documents;
generating, by the processor, a representation template for each of the respective historical enterprise document based on the corresponding metadata;
generating, by the processor, one or more data point identification models for each category of historical documents using the plurality of historical enterprise documents of respective category and the corresponding representation templates;
generating, by the processor, one or more data capture rules within each of the data point identification models, wherein the one or more data capture rules cause the corresponding data point identification model to capture a data value associated with data points in each incoming enterprise-document and transform the data values for storage into another database; and
developing, by the processor, the tool for automated data capture from the generated one or more data point identification models and the generated one or more rules.

2. The method as claimed in claim 1, wherein the plurality of historical enterprise-documents are classified into one or more categories based on a document type using one or more classification techniques.

3. The method as claimed in claim 2, wherein the classification technique includes categorizing the historical enterprise documents based on at least one of: appearance, frequency of occurrence of one or more terms in the historical enterprise documents, text layout and size of the document.

4. The method as claimed in claim 1, wherein one or more document records associated with respective historical enterprise-document are extracted using an index matching technique.

5. The method as claimed in claim 1, wherein generating the metadata corresponding to each historical enterprise-document comprises:
generating the data point representation list corresponding to the data values associated with respective data points in each of the document records using a reverse transformation technique;
performing a search to identify each data point associated with each document record in the corresponding historical enterprise-documents based on the corresponding data point representation list;
marking a position of each identified data point with a special annotation on the corresponding historical enterprise-documents; and
generating the meta-data associated with respective historical enterprise-document based on corresponding special annotation and the data point representation list.

6. The method as claimed in claim 1, wherein the meta-data comprises information associated with one or more data points of an historical enterprise-document, position of each of the one or more data points in the historical enterprise-document, information associated with document type and document structure.

7. The method as claimed in claim 1, wherein each representation template represents multiple data points and meta-data associated with the corresponding historical enterprise documents.

8. The method as claimed in claim 1, wherein generating one or more data capture rules within respective data point identification models comprises:
performing a search for identifying each data point associated with respective document records in the corresponding historical enterprise-documents using the corresponding data point representation list and analyzing a pattern of appearance of the data value associated with each data point in the respective categories of enterprise documents;
identifying a data transformation mechanism for the data values of the identified data points associated with respective enterprise-documents based on a relationship determined between the data value associated with each data point in the respective categories of enterprise documents and a data value in the corresponding historical enterprise-documents;
performing a check to determine availability of one or more keywords at least before or after the data value associated with corresponding identified data points in respective historical enterprise-documents for each category;
performing a check to determine the availability of one or more static texts in respective historical enterprise-documents, if no keywords exists before or after the data value corresponding to the identified data points and building a relationship between the static text and the data values using one or more techniques selected from coordinate geometry and pattern matching technique; and
generating the one or more data capture rules for each category of historical documents using the identified data transformation mechanism and at least one of: the identified keywords and the static text associated with corresponding historical enterprise-documents.

9. The method as claimed in claim 8, wherein each static text is representative of the text that appears in multiple enterprise-documents of a category.

10. A method for generating training data for developing a tool for automated data capture from incoming enterprise documents, wherein the method is implemented by at least one processor executing program instructions stored in a memory, the method comprising:
extracting, by the processor, one or more document records corresponding to respective plurality of historical enterprise-documents using an index matching technique;
generating, by the processor, a metadata for each of the plurality of historical enterprise-documents based on data point representation list associated with corresponding one or more document records, wherein the data point representation list includes multiple representations of data values associated with respective data points in the document records corresponding to historical enterprise documents; and
generating, by the processor, a representation template for respective historical enterprise documents based on the corresponding metadata.

11. The method as claimed in claim 1, wherein one or more data point identification models are generated using the plurality of historical enterprise documents of a category and the corresponding representation templates, wherein the data point identification models are implementable by the tool for automated data capture.

12. The method as claimed in claim 2, wherein one or more data capture rules are generated within each of the data point identification models, wherein the one or more data capture rules cause the corresponding data point identification model to capture a data value associated with data points in each incoming enterprise-document and transform the data values for storage into another database.

13. A system for developing a tool for automated data capture from incoming enterprise documents, the system comprising:
a memory storing program instructions; a processor configured to execute program instructions stored in the memory; and a tool development engine in communication with the processor and configured to:
generate a metadata for each of the plurality of historical enterprise-documents based on corresponding data point representation lists, wherein the data point representation list includes multiple representations of data values associated with data points in the document records corresponding to historical enterprise documents;
generate a representation template for each of the respective historical enterprise document based on the corresponding metadata;
generate one or more data point identification models for each category of historical documents using the plurality of historical enterprise documents of respective category and the corresponding representation templates, wherein the data point identification models are implementable by the tool for automated data capture;
generate one or more data capture rules within each of the data point identification models, wherein the one or more data capture rules cause the corresponding data point identification model to capture a data value associated with data points in each incoming enterprise-document and transform the data values for storage into another database; and
develop the tool for automated data capture from the generated one or more data point identification models and the generated one or more rules.

14. The system as claimed in claim 13, wherein the tool development engine comprises a training unit in communication with the processor, said training unit configured to classify the plurality of historical enterprise-documents into one or more categories based on a document type using one or more classification techniques.

15. The system as claimed in claim 14, wherein the classification technique includes categorizing the historical enterprise documents based on at least one of: appearance, frequency of occurrence of one or more terms in the historical enterprise documents, text layout and size of the document.

16. The system as claimed in claim 14, wherein the training unit is configured to extract one or more document records associated with respective historical enterprise-document using an index matching technique.

17. The system as claimed in claim 13, wherein the tool development engine comprises a training unit in communication with the processor, said training unit configured to generate the metadata corresponding to each historical enterprise-document by:
generating the data point representation list corresponding to the data values associated with respective data points in respective document records using a reverse transformation technique;
performing a search to identify each data point associated with each document record in the corresponding historical enterprise-documents based on the corresponding data point representation list;
marking a position of each identified data point with a special annotation on the corresponding historical enterprise-documents; and
generating the meta-data associated with respective historical enterprise-document based on corresponding special annotation and the data point representation list.

18. The system as claimed in claim 13, wherein the meta-data comprises information associated with one or more data points of an historical enterprise-document, position of each of the one or more data points in the historical enterprise-document, information associated with document type and document structure.

19. The system as claimed in claim 13, wherein each representation template represents multiple data points and meta-data associated with the corresponding historical enterprise documents.

20. The system as claimed in claim 13, wherein the tool development engine comprises a model generation unit in communication with the processor, said model generation unit configured to generate one or more data capture rules within respective data point identification models by:
performing a search for identifying each data point associated with respective document records in the corresponding historical enterprise-documents using the corresponding data point representation list and analyzing a pattern of appearance of the data value associated with each data point in the respective categories of enterprise documents;
identifying a data transformation mechanism for the data values of the identified data points associated with respective enterprise-documents based on a relationship determined between the data value associated with each data point in the respective categories of enterprise documents and a data value in the corresponding historical enterprise-documents;
performing a check to determine availability of one or more keywords at least before or after the data value associated with corresponding identified data points in respective historical enterprise-documents for each category;
performing a check to determine the availability of one or more static texts in respective historical enterprise-documents, if no keywords exists before or after the data value corresponding to the identified data points and building a relationship between the static text and the data values using one or more techniques selected from coordinate geometry and pattern matching technique; and
generating the one or more data capture rules for each category of historical documents using the identified data transformation mechanism and at least one of: the identified keywords and the static text associated with corresponding historical enterprise-documents.

21. The system as claimed in claim 20, wherein each static text is representative of the text that appears in multiple enterprise-documents of a category.

22. A system for generating training data for developing a tool for automated data capture from incoming enterprise documents, the system comprising:
a memory storing program instructions; a processor configured to execute program instructions stored in the memory; and a tool development engine in communication with the processor and configured to:
extract one or more document records corresponding to respective plurality of historical enterprise-documents using an index matching technique;
generate a metadata for each of the plurality of historical enterprise-documents based on data point representation list associated with corresponding one or more document records, wherein the data point representation list includes multiple representations of data values associated with respective data points in the document records corresponding to historical enterprise documents; and
generate a representation template for respective historical enterprise documents based on the corresponding metadata, wherein the one or more data point identification models are generated using the plurality of historical enterprise documents of a category and the corresponding representation templates, wherein the data point identification models are implementable by the tool for automated data capture.

23. The system as claimed in claim 22, wherein one or more data capture rules are generated within each of the data point identification models, wherein the one or more data capture rules cause the corresponding data point identification model to capture a data value associated with data points in each incoming enterprise-document and transform the data values for storage into another database.
